(19) United States
(12) Patent Application Publication
(10) Pub. No.: US 2017/0367466 A1
(43) Pub. Date: Dec. 28, 2017

(54) Techslate

(71) Applicant: Eddie Lewis Disnute, Jonesboro, GA (US)

(72) Inventor: Eddie Lewis Disnute, Jonesboro, GA (US)

(21) Appl. No.: 14/999,769

(22) Filed: Jun. 27, 2016

(51) Int. Cl. A45F 5/00; A45F 3/14; G06F 1/16

(52) U.S. Cl. CPC A45F 5/00; G06F 1/163; A45F 3/14; A45F 2003/142; A45F 2003/146; A45F 2003/144

(57) ABSTRACT

Techslate is an apparatus having component parts producing a surface plane(s) for load, operation, and viewing of mobile devices like smart phones, tablets, computers, alphanumeric keyboards, integrated CPUs, electronic equipment, literary mediums, etc., offering solutions for hands free, ambulant operation. Devices and components are mounted, secured, embedded, engineered in or onto the apparatus, which has balanced mid-upper suspension mechanisms securing it at appropriate viewing and operation angles from the human body by neck, shoulder, chest straps and/or braces. The apparatus's lower end attaches around the waist or torso of the human body with variable tension controlled band mechanisms. (i.e. elastic, Velcro, magnets, slots, springs, positioned locking, etc.). Utility and functionality of this apparatus is created by the principles employed, so as the apparatus's component parts are sufficient to handle the load, viewing and operation of devices which are embedded, mounted, integrated, and secured to the apparatus.

### RELATED U.S. PATENT DOCUMENTS

U.S. Pat. No. 4,491,325 January 1985 Bersheim

US 20080054039 A1 Mar. 6, 2008 Wulff, et al.

The present application claims the benefit of the following U.S. Provisional Patent application No. 62/231,159 filed Jun. 27, 2015

### DESCRIPTION

Most mobile device docking stations are TechSlate is a simple machine/invention put together of component parts in such a way as to allow a full 180° lateral and 90° viewing range, operation and listening of mobile devices such as cell phones, computer tablets, tablets, books, and magazines without holding it with the hands.

It consists of singular/multiple fixed and suspended rotating plane(s), which allow the attachment (mounting, docking, etc) of mobile communication devices and similar technologies to the plane(s) by rubber/elastic and other apparatuses attached to said planes, using suspended/support structure(s), as a neck/waist/shoulder straps/harness(es), thereby allowing said devices to be held in place on said planes permitting the operation, viewing, listening and multitasking of said mobile devices.

TechSlate is a machine, invention, product, apparatus that is manufactured, put together, assembled, contrived, invented, in such a way as having total component parts that produces a inclined plane at an angle or angles from the human body by way of suspension mechanisms from the upper human body region, (i.e, neck, shoulders, chest) connected to the upper or mid regions of the plane or multiple planes, including tiered planes (s) allowing the lower end of the inclined plane to rest or be anchored on the abdomen, waist or lower areas of the human body with methods (i.e., elastic waist band, Velcro, magnets. etc) of securing said plane(s) bottom end to said lower body area, whereby stability is created sufficient enough so that a mobile device or multiple mobile devices can be mounted on tiered planes connected and or attached to the apparatus incline plane(s) for viewing and operation of singular or multiple mobile devices without holding the device(s) with the hands.

It consists of singular/multiple fixed and suspended rotating plane(s), which allow the attachment (mounting, docking, etc) of mobile communication devices and similar technologies to the plane(s) by rubber/elastic and other apparatuses attached to said planes, using suspended I support structure(s), as a neck I waist I shoulder straps I harness(es), thereby allowing said devices to be held in place on said planes permitting the operation, viewing, listening and multitasking of said mobile devices.

TechSlate is secured and worn on the body by balanced suspension, using adjustable neck/shoulder strap(s) attached at a balanced point(s) of the plane; it is secured at the bottom end by a lightweight waist band going around the waist allowing TechSlate to achieve varied viewing degrees and operation angles of attached mobile devices without holding the device with the hand(s).

TechSlate works by the mobile device being attached (with rubber bands and other apparatuses) on the upper regions of the plane(s) TechSlate.

The lower end of the plane(s) TechSlate, rests on the abdominal area and is secured/anchored by an adjustable waist band going around the waist, having each end of the waist band attached to each side of the bottom end of the TechSlate.

This allows a sturdy, taunt point of anchoring and pivoting of the bottom end so that the neck/shoulder strap, attached to a balanced point under the mounted device (not intruding on the viewing area of the device's screen), allowing TechSlate to provide varied viewing angles of degree for the mobile device mounted to it.

Various models and designs can be formulated and constructed to cover a wide spectrum of peripheral components as follows:
Multi-tiered, interchangeable units and add-on components
Privacy shield and sun visors
Geometrically designed Techslate body patterns
Low voltage viewing and running lights
Protective water proof screen covers
Storage compartments
Cloth, vinyl, leather, plastic covers with zipper/Velcro/snaps storage compartments.
Backup battery power source/charger
Multi channel input-output headphone/speaker connector.

All construction materials of the TechSlate should be sturdy and lightweight, and can be manufactured from current available commercial products on the market such as all forms of cardboard, plastics, wood, and certain types of foam. Metal s not recommended due to possible impalement issues.

A product with as much malleability as the TechSlate has the magnitude to generate revenue in areas of marketing, manufacturing, sales and tax. A new type of product coupled with an oncoming strain of versions and accessories require designers, thinkers, and workers; therefore the TechSlate would produce jobs and greatly impact the National GDP over time.

Correctly incorporating the TechSlate in working environments can also increase the efficiency and productivity of employees in fields where the use of mobile devices is essential to conducting research and everyday business in the work place.

### TECHSLATE

### Specification

Claims of my invention embody principles, systems and methods that produce tiered plane(s) connected to or upon a suspended stationary primary incline plane(s) in such a way that allows and creates a singular fixed axis or multiple axis for said connected tiered planes. Connected and secured to the/a primary incline plane (s) by bolt(s) and nut(s), rivets, snaps, shaft(s) or other materials and methods satisfactory towards achieving such desired affects to create, and express a friction center axis(s) of rotation of the tiered plane(s), which is positioned at a point or points through, or upon the primary incline plane(s) surface. The created axis(s) should allow the tiered plane(s) ability to rotate 360° upon the stationary primary incline plane(s) surface, with enough friction existing between the bottom surface of the tiered plane and the top surface of the primary incline plane's surface, supplying the tension needed to stop the free rotation of the tiered plane.

A mobile device(s) is mounted on the top surface of the tiered plane(s) and held in place by rubber bands, mobile device cradle, Velcro, a slip holder or other methods by which a mobile device can be mounted on, around, in or through the tiered plane(s) surface in such a way as to secure the mobile device(s) to the tiered plane(s) surface while the tiered plane remains in place on the stationary primary plane(s) surface by means of the above mentioned axis, allowing a 90° to 180° viewing range, and operation of mobile device(s) e.g., cell phones, computer tablets, tablets, mini-books, magazines, etc., without holding the device(s) with the hands.

The primary plane(s) upper region is suspended on the body by a balanced triangular, or parallel suspension system attached to the stationary primary plane coupled to a neck/shoulder strap/upper body harness or other means as to allow the primary plane(s) to be suspended and balanced enabling the desired effect for the mobile device's viewing and operation within the scope of this utility design.

The lower end of the stationary primary incline plane rests upon the abdomen secured at the bottom end of the said incline plane by a lightweight waist elastic band attached to either side of the lower portion of the primary incline plane, going around the body for bottom end stability, (or other means of stabilizing the plane's bottom end, i.e,—Velcro, magnetic couplings, hooking mechanism, etc.) allowing a resting point for the suspended stationary incline primary plane.

### STATEMENT OF CLAIMS

Thus, in view of the many possible embodiments to which my invention reveals within the disclosed principles to be applied, it should be recognized that the above-described embodiments are only examples and should not be taken as limiting in scope. I therefore reserve all rights to the subject matter disclosed herein, including the right to claim all that comes within the scope and spirit of the above and following claims.
(1) A machine, product, apparatus that is manufactured, put together, assembled, contrived, invented, in such a way as having total component parts that produces a inclined plane at an angle or angles from the human body by way of (2) suspension mechanisms from the upper human body region, (i.e, neck, shoulders, chest) connected to the upper or mid regions of the plane or multiple planes, including tiered planes (s) (3) allowing the lower end of the inclined plane to rest or be anchored on the abdomen, waist or lower areas of the human body with methods (i.e., elastic waist band, Velcro, magnets. etc) of securing said plane(s) bottom end to said lower body area, whereby (4) stability is created by the total principles employed becomes sufficient enough so that a mobile device or multiple mobile devices can be mounted on tiered planes connected and/or attached to the apparatus primary incline plane(s) for viewing and operation of singular or multiple mobile devices without holding the device(s) with the hands.

### SUMMARY

The principles disclosed and described herein contemplates other embodiments based on the wide variety of system knowledge, principles and procedures associated with those of ordinary skills in the arts associated with the mentioned apparatus. Various modifications of these embodiments are apparent to those having the mental capacity to visualize other embodiments and principles within the scope and spirit of this disclosure.

Having said this, the claimed invention(s) are/is not limited to the embodiments shown, but shall be viewed in the full scope and reach for which the invention exists and bears claim to. Because of the many possible embodiments found within the structural and functional equivalents to the elements described throughout the disclosure being known or later to be known to those of ordinary skill in the embodied arts, I therefore reserve all rights to the subject matter, claiming all the rights that come within the realm and scope of the mentioned principles, and embodiments mentioned in the scope and spirit of this apparatus.

What is claimed is:

1. An apparatus comprising:
a plane(s) with upper and lower suspension systems,
tension mechanisms, electronics and device mounts for the apparatus's load, operation, and viewing of mounted, integrated, embedded mobile devices and mediums (i.e., smart phones, tablets, computers, alphanumeric keyboards, electronic equipment, literary mediums, etc.), at various angles from the human body for hands free, ambulant operation of these devices and mediums.
A. The apparatus of claim 1, said apparatus embodies integration and embeddedness of electronics wherein the lower regions of the apparatus contains a CPU, battery and other components with the mid-upper regions of the apparatus contains a touchscreen, alphanumeric keyboard, viewing lights, sunscreen hood visors and/or other peripheral augmentations.
B. The apparatus of claim 1, said apparatus comprise single, multiple, and tiered planes. (branching-off, and/or attached to a primary plane(s)).
C. The apparatus of claim 1, said apparatus, the claimed inventions and stated claims, are not intended to be limited to the claims and embodiments shown herein, but are to be accorded the full scope consistent with the language, utility, design and functionality of the claim.
